(19) United States
(12) Patent Application Publication
(10) Pub. No.: US 2025/0368439 A1
(43) Pub. Date: Dec. 4, 2025

(54) WEDGE STOP FOR AN AUTOMATED STORAGE AND RETRIEVAL SYSTEM

(71) Applicant: Intelligrated Headquarters, LLC, Mason, OH (US)

(72) Inventor: Justin Michael Brouk, Cincinnati, OH (US)

(21) Appl. No.: 18/677,394

(22) Filed: May 29, 2024

(51) Int. Cl. B65G 1/04

(52) U.S. Cl. CPC B65G 1/0492

(57) ABSTRACT

A wedge stop for an automated storage and retrieval system is provided. The wedge stop includes a sloped surface that is configured to receive a wheel of the automated storage and retrieval system.

### TECHNICAL FIELD

The present application relates generally relates to an automated storage and retrieval system. More specifically, the present application relates to a wedge stop for stopping a shuttle of the automated storage and retrieval system.

### BACKGROUND

Automated storage and retrieval systems often include one or more shuttles that move along racking of the automated storage and retrieval system. The shuttles often include wheels and a means for stopping the shuttle, such as braking means that are powered with electric. In the event that the means for stopping the shuttle malfunctions or is no longer powered, the shuttle may continue to move along the racking via the wheels. Automated storage and retrieval systems often include bumpers positioned at the end of the racking to stop the shuttle in the event that the means for stopping the shuttle malfunctions or loses power. The bumpers are positioned such that a body of the shuttle collides with the bumpers, which effectively stops the shuttle. However, the impact of the bumper onto the body of the shuttle may cause damage to the housing of the shuttle or components, such as electrical components, that are within the housing.

The inventor has identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include systems and apparatuses to provide for improved automated storage and retrieval systems. More specifically, the present application relates to a wedge stop for stopping a shuttle of the automated storage and retrieval system.

In various aspects, an automated storage and retrieval system comprises racking comprising a plurality of rails, a shuttle comprising a wheel that is configured to roll along at least one of the plurality of rails along a linear rolling path, and a wedge stop coupled, directly or indirectly, to the racking and proximate to the linear rolling path. The wedge stop may comprise a sloped surface that is configured to receive the wheel as the wheel is rolling along the linear rolling path.

In various examples, the wedge stop is configured to progressively slow and stop the rolling of the wheel along the linear rolling path.

In various examples, the sloped surface of the wedge stop defines a slope angle relative to the linear rolling path, wherein the slope angle is at least one degree and up to three degrees.

In various examples, the wedge stop comprises a depression.

In various examples, the depression of the wedge stop defines a first radius of curvature and the wheel defines a second radius of curvature, wherein the first radius of curvature is within five percent of the second radius of curvature.

In various examples, the wedge stop comprises a first end and a second end, wherein a first thickness of the wedge stop at the first end is less than a second thickness of the wedge stop at the second end, and wherein the depression is positioned within one inch of the second end.

In various examples, the wedge stop has a longitudinal length and the depression defines a longitudinal distance, where a ratio between the longitudinal length and the longitudinal distance is at least 4:1 and up to 7:1.

In various examples, the wedge stop has a longitudinal length and the depression defines a longitudinal distance, where a ratio between the longitudinal length and the longitudinal distance is at least 4:1 and up to 7:1.

In various examples, the sloped surface of the wedge stop comprises a channel, wherein a width of the channel is within five percent of a width of a rolling surface of the wheel.

In various examples, the wedge stop is configured to progressively slow and stop the rolling of the wheel along the linear rolling path, the sloped surface of the wedge stop defines a slope angle relative to the linear rolling path, wherein the slope angle is at least one degree and up to three degrees, the wedge stop comprises a depression, the depression of the wedge stop defines a first radius of curvature and the wheel defines a second radius of curvature, wherein the first radius of curvature is within five percent of the second radius of curvature, the wedge stop comprises a first end and a second end, wherein a first thickness of the wedge stop at the first end is less than a second thickness of the wedge stop at the second end, the depression is positioned within one inch of the second end, the wedge stop has a longitudinal length and the depression defines a longitudinal distance, where a ratio between the longitudinal length and the longitudinal distance is at least 4:1 and up to 7:1, and the sloped surface of the wedge stop comprises a channel, wherein a width of the channel is within five percent of a width of a rolling surface of the wheel.

In various aspects, a wedge stop for an automated storage and retrieval system comprises a sloped surface that is configured to receive a wheel of the automated storage and retrieval system.

In various examples, the wedge stop is configured to progressively slow and stop the rolling of the wheel.

In various examples, the sloped surface of the wedge stop defines a slope angle, wherein the slope angle is at least one degree and up to three degrees.

In various examples, the wedge stop comprises a depression.

In various examples, the depression of the wedge stop defines a first radius of curvature and the wheel defines a second radius of curvature, wherein the first radius of curvature is within five percent of the second radius of curvature.

In various examples, the wedge stop comprises a first end and a second end, wherein a first thickness of the wedge stop at the first end is less than a second thickness of the wedge stop at the second end, and wherein the depression is positioned within one inch of the second end.

In various examples, the wedge stop has a longitudinal length and the depression defines a longitudinal distance, where a ratio between the longitudinal length and the longitudinal distance is at least 4:1 and up to 7:1.

In various examples, the wedge stop has a longitudinal length and the depression defines a longitudinal distance, where a ratio between the longitudinal length and the longitudinal distance is at least 4:1 and up to 7:1.

In various examples, the sloped surface of the wedge stop comprises a channel, wherein a width of the channel is within five percent of a width of a rolling surface of the wheel.

In various examples, the wedge stop is configured to progressively slow and stop the rolling of the wheel, the sloped surface of the wedge stop defines a slope angle, the slope angle is at least one degree and up to three degrees, the wedge stop comprises a depression, the depression of the wedge stop defines a first radius of curvature and the wheel defines a second radius of curvature, wherein the first radius of curvature is within five percent of the second radius of curvature, the wedge stop comprises a first end and a second end, wherein a first thickness of the wedge stop at the first end is less than a second thickness of the wedge stop at the second end, the depression is positioned within one inch of the second end, the wedge stop has a longitudinal length and the depression defines a longitudinal distance, where a ratio between the longitudinal length and the longitudinal distance is at least 4:1 and up to 7:1, and the sloped surface of the wedge stop comprises a channel, wherein the width of the channel is within five percent of a width of a rolling surface of the wheel.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides an isometric view of an automated storage and retrieval system, in accordance with an example embodiment.

FIGS. 2-6 provide isometric views of the automated storage and retrieval system of FIG. 1, in accordance with an example embodiment.

FIG. 7 provides an isometric view of a wedge stop of the automated storage and retrieval system of FIG. 1, in accordance with an example embodiment.

FIG. 8 provides a side view of the wedge stop of FIG. 7, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “positioned directly on” refers to a first component being positioned on a second component such that they make contact. Similarly, as used herein, the term “positioned directly between” refers to a first component being positioned between a second component and a third component such that the first component makes contact with both the second component and the third component. In contrast, a first component that is “positioned between” a second component and a third component may or may not have contact with the second component and the third component. Additionally, a first component that is “positioned between” a second component and a third component is positioned such that there may be other intervening components between the second component and the third component other than the first component.

As used herein, the term “proximate to,” “near,” or the like, refers to a first component being positioned within three inches, such as within two inches, such as within 1 inch, of the other component or area specified.

As used herein, terms of approximation, such as “approximately,” “substantially,” or “about,” refer to being within manufacturing or engineering tolerances. For example, terms of approximation may refer to being within a five percent margin of error. Detailed Description

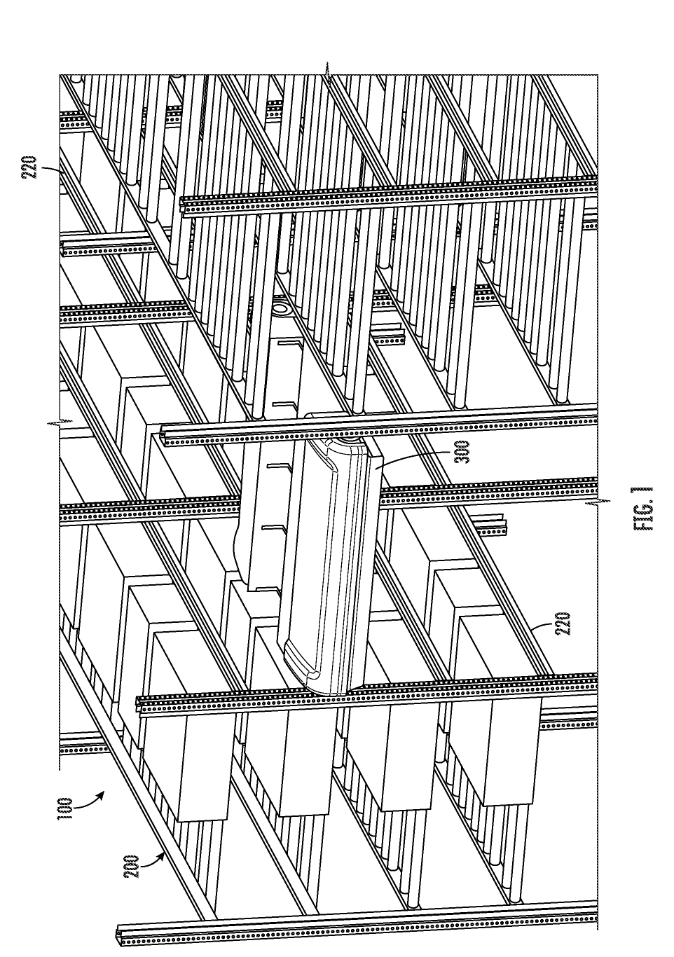

Referring now to FIG. 1, an isometric view of an automated storage and retrieval system 100 is provided, in accordance with an example embodiment. The automated storage and retrieval system 100 may include racking 200 comprising a plurality of rails 220 and at least one shuttle 300. Each shuttle 300 of the automated storage and retrieval system 100 may be configured to retrieve or place objects (e.g., boxes, parcels, or bins) from or onto the racking 200, such as from or onto a shelf of the racking 200.

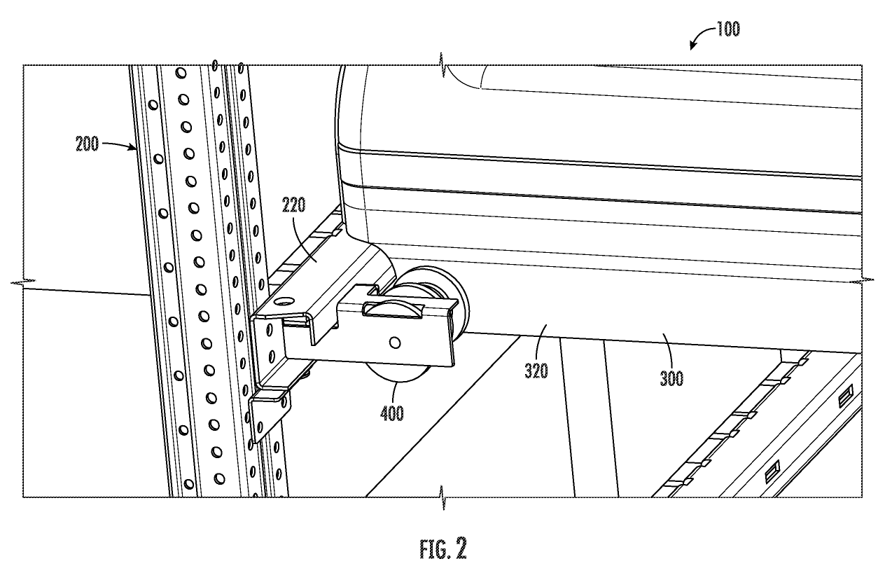

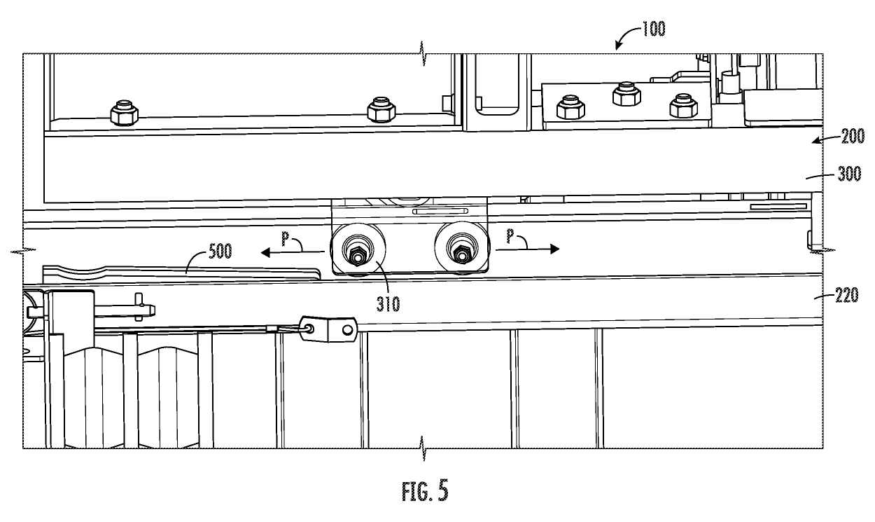

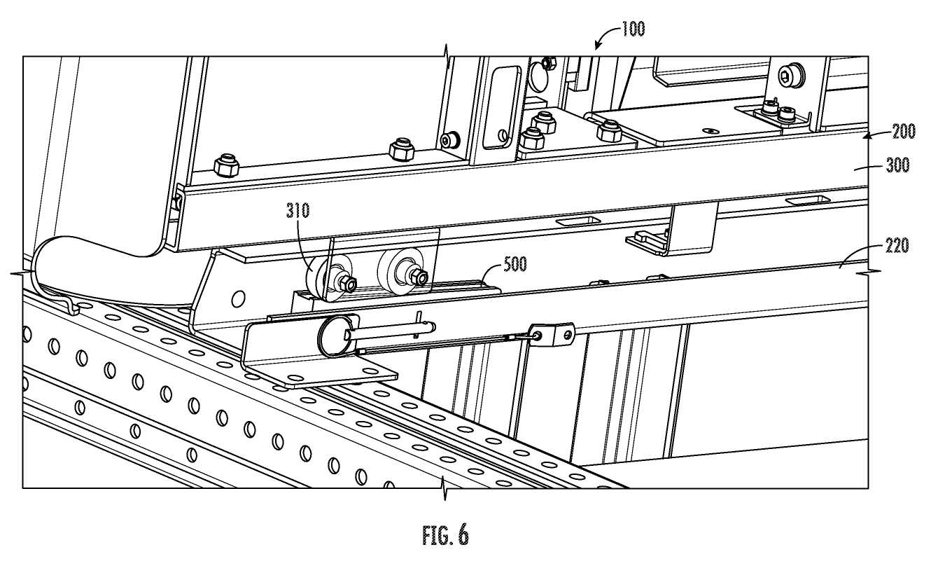

Referring now to FIGS. 2-6, various views of the automated storage and retrieval system 100 of FIG. 1 are provided, in accordance with an example embodiment. Each shuttle 300 may comprise a plurality of wheels 310. The wheels 310 may be configured to allow the shuttle 300 to move along the racking 200. Each shuttle 300 may include a braking means (not depicted) that is configured to slow and stop the shuttle 300 from moving relative to the racking 200. The braking means may be powered with electricity.

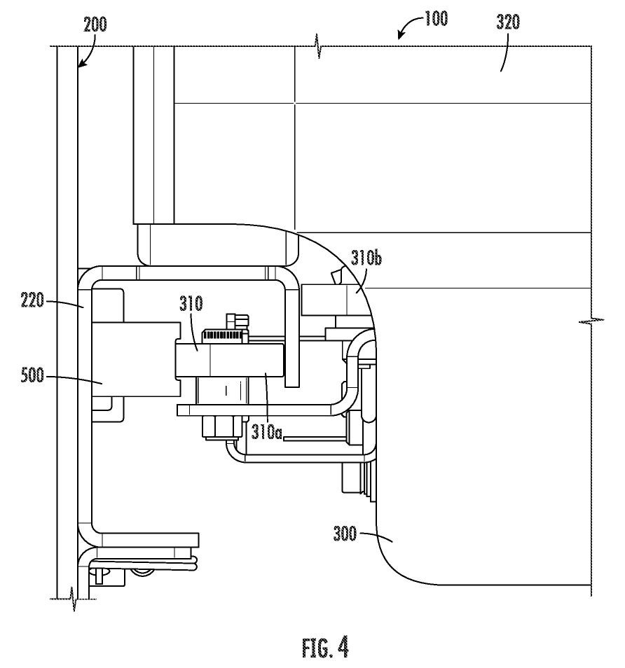

In various examples, at least one of the wheels 310 may be configured to roll along at least one of the plurality of rails 220 of the racking 200 along a linear rolling path P, which may extend horizontally. With reference to FIG. 4, the wheel 310 may be a component of a wheel 310 assembly that comprises a plurality of wheels 310. The wheel 310a of the wheel 310 assembly may be configured to roll along a first side of a rail 220 and a second wheel 310b of the wheel 310 assembly may be configured to roll along a second side of the rail 220 that is opposite the first side of the wheel 310. In this way, the first wheel 310a and the second wheel 310b of the wheel 310 assembly may collectively straddle the rail 220 as the first wheel 310a and the second wheel 310b roll along the rail 220.

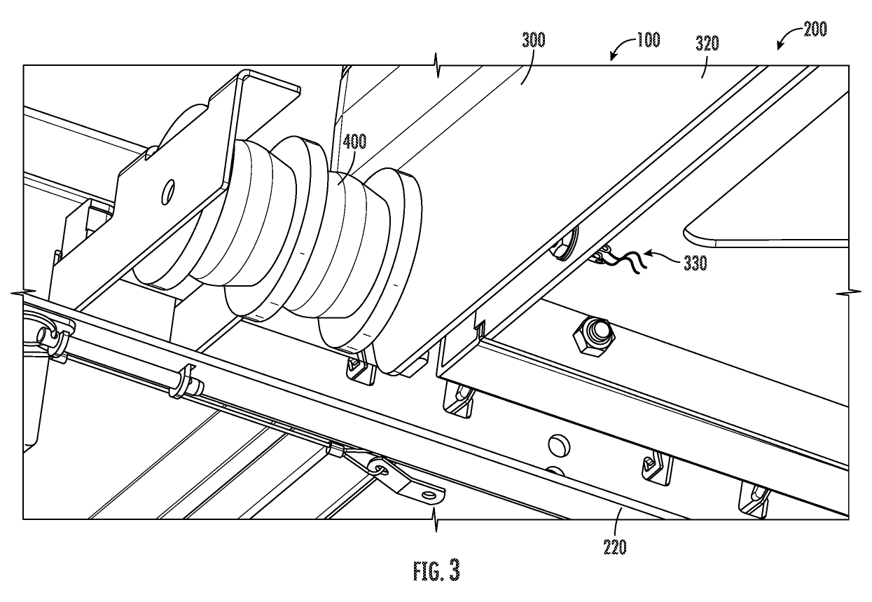

In various examples, and with reference to FIG. 3, the automated storage and retrieval system 100 may comprise a bumper 400. The bumper 400 may be configured as a rubber gasket bumper 400 and may be coupled to an end of the racking 200. The bumper 400 may be configured to stop the shuttle 300 in the event that the main means of stopping the shuttle 300 (e.g., the braking means) malfunctions or is no longer receiving electrical power. The bumper 400 may not be intended for use when the shuttle 300 is operating normally. In some instances when the bumper 400 is used, the collision of the shuttle 300 with the bumper 400 may cause damage to the shuttle 300. For example, the impact of the shuttle 300 against the bumper 400 may cause damage to a housing 320 of the shuttle 300 or to various components 330, such as electrical components 330, of the shuttle 300 that are positioned proximate to the location where the bumper 400 impacts the shuttle 300. The components 330 may become damaged when the bumper 400 impacts the shuttle 300. As such, it may be beneficial to slow or stop the shuttle 300 prior to the shuttle 300 impacting the bumper 400 with a wedge stop 500, which will be discussed further. In various examples, a bumper 400 is not provided within the automated storage and retrieval system 100 and the wedge stop 500 is provided that slows and stops the shuttle 300 to prevent the shuttle 300 from being derailed from the racking 200 in the event that the main means of stopping the shuttle 300 malfunctions or is no longer receiving electrical power.

As discussed, the automated storage and retrieval system 100 may comprise a wedge stop 500. The wedge stop 500 may be manufactured from an elastomer, such as a rubber. The wedge stop 500 may be coupled, directly or indirectly, to the racking 200 and proximate to the linear rolling path. For example, and with reference to FIG. 4, the wedge stop 500 may be coupled to the same rail 220 that the wheel 310 is configured to roll along. The rail 220 may be generally C-shaped and both the wedge stop 500 and the wheel 310 may be positioned within the C-shaped rail 220. As will be discussed further, the wedge stop 500 may be configured to exert a compressive force onto the wheel 310, which is positioned directly between the wedge stop 500 and the rail 220, which may slow the rolling of the wheel 310 until the wheel 310 stops.

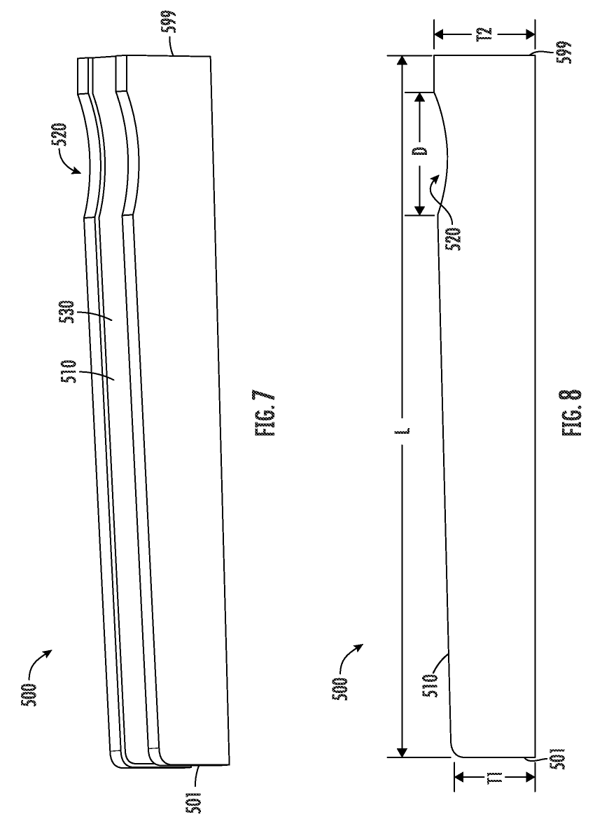

Referring now to FIGS. 7-8, an isometric view and a side view of the wedge stop 500 are provided, in accordance with an example embodiment. The wedge stop 500 may be configured to progressively slow and stop the rolling of the wheel 310 along the linear rolling path P. The wedge stop 500 may include a sloped surface 510 that is configured to receive the wheel 310 as the wheel 310 is rolling along the linear rolling path P, which may cause the wheel 310 to slow and/or stop. The sloped surface 510 of the wedge stop 500 may define a slope angle relative to the linear rolling path. The slope angle may be at least one degree and up to three degrees, such as at least one degree and up to two degrees, such as at least one degree and up to 1.5 degrees. For example, the slope angle may be 1.45 degrees, 1.5 degrees, 1.75 degrees, 2 degrees, 2.25 degrees, 2.5 degrees, or 2.75 degrees, to name a few specific examples.

In various examples, the wedge stop 500 includes a depression 520. The depression 520 may be a concave portion that is formed on the sloped surface 510 of the wedge stop 500. The depression 520 of the wedge stop 500 may define a first radius of curvature an that is within five percent, such as within two percent of a second radius of curvature defined by the wheel 310. As such, the depression 520 of the wedge stop 500 may be configured to allow the wheel 310 of the shuttle 300 to rest within the depression 520. The depression 520 may retain the wheel 310 within the depression 520 and prevent further movement of the shuttle 300. For example, when the wheel 310 of the shuttle 300 is rolling forward along the linear rolling path towards the wedge stop 500, once the wheel 310 is positioned within the depression 520, the depression 520 may prevent the wheel 310 from rolling backward along the linear rolling path.

In various examples, the wedge stop 500 has a first end 501 and a second end 599. A first thickness T1 of the wedge stop 500 at the first end 501 may be less than a second thickness T2 of the wedge stop 500 at the second end 599. The depression 520 may be positioned within one inch of the second end 599. The wedge stop 500 may have a longitudinal length L and the depression 520 may define a longitudinal distance D. A ratio (L:D) between the longitudinal length L and the longitudinal distance D may be at least 4:1 and up to 7:1. A ratio (L:D) that is at least 4:1 and up to 7:1 and positioning the depression 520 within one inch of the second end 599 may be beneficial to allow a length of the sloped surface 510 to sufficiently slow the wheel 310 prior to the wheel 310 being positioned within the depression 520. As will be appreciated, if the wheel 310 is not sufficiently slowed prior to being positioned within the depression 520, the wheel 310 may overrun the depression 520 or bounce backwards and away from the depression 520 and, subsequently, away from the wedge stop 500.

In various examples, the sloped surface 510 of the wedge stop 500 includes a channel 530. A width of the channel 530 may be within five percent, such as within two percent of a width of a rolling surface of the wheel 310. As such the channel 530 may be configured to retain the wheel 310 within the channel 530 and prevent the wheel 310 from rolling away from the wedge stop 500 in a direction orthogonal to the linear rolling path.

During operation of the automated storage and retrieval system 100, and as previously discussed, the main means of stopping the shuttle 300 may malfunction or inadvertently no longer receive electrical power. When this occurs when the shuttle 300 is moving along the rails 220 of the racking 200, the shuttle 300 may undesirably and unintentionally continue to move along the rails 220 of the racking 200. For example, the wheels 310 of the shuttle 300 may each continue to roll along their respective linear rolling paths P. At least one wedge stop 500, such as a plurality of wedge stops 500, may each be positioned proximate to a respective linear rolling path P of a respective wheel 310 to slow and stop the respective wheel 310. For example, the wheel 310 of the shuttle 300 may roll along the linear rolling path P and towards the wedge stop 500. Subsequently, the wheel 310 may roll onto and up the sloped surface 510 of the wedge stop 500. In various examples, the wheel 310 rolls within the channel 530 defined on the sloped surface 510. As best viewed in FIG. 4, the sloped surface 510 may exert a gradual compressive force onto the wheel 310 as the wheel 310 progressively rolls along the sloped surface 510 because the wheel 310 is positioned directly between the sloped surface 510 and a stationary rail 220 of the racking 200. Exerting the gradual compressive force as the wheel 310 moves along the sloped surface 510 may gradually slow the rolling of the wheel 310 and may stop the rolling of the wheel 310. The position and depth of the depression 520 may be tailored to optimize the speed of the shuttle 300 when the wheel 310 of the shuttle 300 reaches the depression 520. For example, a sufficient length of the sloped surface 510 may be provided to sufficiently allow the wheel 310 to reach the depression 520 while also sufficiently slowing the wheel 310 prior to reaching the depression 520. As discussed, it is beneficial for the wheel 310 to slowly roll into the depression 520 to prevent the wheel 310 from overrunning the depression 520 or being bounced out of the depression 520.

The automated storage and retrieval system 100 that includes a wedge stop 500 has various benefits. For example, the wedge stop 500 may slow and stop the shuttle 300 of the automated storage and retrieval system 100 without causing damage to the shuttle 300. As discussed, providing bumpers 400 may cause damage to components, such as electrical components 330 of the shuttle 300, when the main body of the shuttle 300 impacts the bumper 400. In contrast, the wedge stop 500 only makes contact with the wheels 310 of the shuttle 300. As such, damage to components within the main body of the shuttle 300 may be prevented with use of the wedge stop 500 to slow and stop the shuttle 300.

### CONCLUSION

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An automated storage and retrieval system comprising:
racking comprising a plurality of rails;
a shuttle comprising a wheel that is configured to roll along at least one of the plurality of rails along a linear rolling path; and
a wedge stop coupled, directly or indirectly, to the racking and proximate to the linear rolling path, wherein the wedge stop comprises a sloped surface that is configured to receive the wheel as the wheel is rolling along the linear rolling path.

2. The automated storage and retrieval system of claim 1, wherein the wedge stop is configured to progressively slow and stop the rolling of the wheel along the linear rolling path.

3. The automated storage and retrieval system of claim 1, wherein the sloped surface of the wedge stop defines a slope angle relative to the linear rolling path, wherein the slope angle is at least one degree and up to three degrees.

4. The automated storage and retrieval system of claim 1, wherein the wedge stop comprises a depression.

5. The automated storage and retrieval system of claim 4, wherein the depression of the wedge stop defines a first radius of curvature and the wheel defines a second radius of curvature, wherein the first radius of curvature is within five percent of the second radius of curvature.

6. The automated storage and retrieval system of claim 5, wherein the wedge stop comprises a first end and a second end, wherein a first thickness of the wedge stop at the first end is less than a second thickness of the wedge stop at the second end, and wherein the depression is positioned within one inch of the second end.

7. The automated storage and retrieval system of claim 6, wherein the wedge stop has a longitudinal length and the depression defines a longitudinal distance, where a ratio between the longitudinal length and the longitudinal distance is at least 4:1 and up to 7:1.

8. The automated storage and retrieval system of claim 5, wherein the wedge stop has a longitudinal length and the depression defines a longitudinal distance, where a ratio between the longitudinal length and the longitudinal distance is at least 4:1 and up to 7:1.

9. The automated storage and retrieval system of claim 1, wherein the sloped surface of the wedge stop comprises a channel, wherein a width of the channel is within five percent of a width of a rolling surface of the wheel.

10. The automated storage and retrieval system of claim 1, wherein:
the wedge stop is configured to progressively slow and stop the rolling of the wheel along the linear rolling path,
the sloped surface of the wedge stop defines a slope angle relative to the linear rolling path, wherein the slope angle is at least one degree and up to three degrees,
the wedge stop comprises a depression,
the depression of the wedge stop defines a first radius of curvature and the wheel defines a second radius of curvature, wherein the first radius of curvature is within five percent of the second radius of curvature,
the wedge stop comprises a first end and a second end, wherein a first thickness of the wedge stop at the first end is less than a second thickness of the wedge stop at the second end,
the depression is positioned within one inch of the second end,
the wedge stop has a longitudinal length and the depression defines a longitudinal distance, where a ratio between the longitudinal length and the longitudinal distance is at least 4:1 and up to 7:1, and
the sloped surface of the wedge stop comprises a channel, wherein a width of the channel is within five percent of a width of a rolling surface of the wheel.

11. A wedge stop for an automated storage and retrieval system, the wedge stop comprising a sloped surface that is configured to receive a wheel of the automated storage and retrieval system.

12. The wedge stop of claim 11, wherein the wedge stop is configured to progressively slow and stop the rolling of the wheel.

13. The wedge stop of claim 11, wherein the sloped surface of the wedge stop defines a slope angle, wherein the slope angle is at least one degree and up to three degrees.

14. The wedge stop of claim 11, wherein the wedge stop comprises a depression.

15. The wedge stop of claim 14, wherein the depression of the wedge stop defines a first radius of curvature and the wheel defines a second radius of curvature, wherein the first radius of curvature is within five percent of the second radius of curvature.

16. The wedge stop of claim 15, wherein the wedge stop comprises a first end and a second end, wherein a first thickness of the wedge stop at the first end is less than a second thickness of the wedge stop at the second end, and wherein the depression is positioned within one inch of the second end.

17. The wedge stop of claim 16, wherein the wedge stop has a longitudinal length and the depression defines a longitudinal distance, where a ratio between the longitudinal length and the longitudinal distance is at least 4:1 and up to 7:1.

18. The wedge stop of claim 15, wherein the wedge stop has a longitudinal length and the depression defines a longitudinal distance, where a ratio between the longitudinal length and the longitudinal distance is at least 4:1 and up to 7:1.

19. The wedge stop of claim 11, wherein the sloped surface of the wedge stop comprises a channel, wherein a width of the channel is within five percent of a width of a rolling surface of the wheel.

20. The wedge stop of claim 11, wherein:
the wedge stop is configured to progressively slow and stop the rolling of the wheel,
the sloped surface of the wedge stop defines a slope angle,
the slope angle is at least one degree and up to three degrees,
the wedge stop comprises a depression,
the depression of the wedge stop defines a first radius of curvature and the wheel defines a second radius of curvature, wherein the first radius of curvature is within five percent of the second radius of curvature,
the wedge stop comprises a first end and a second end, wherein a first thickness of the wedge stop at the first end is less than a second thickness of the wedge stop at the second end,
the depression is positioned within one inch of the second end,
the wedge stop has a longitudinal length and the depression defines a longitudinal distance, where a ratio between the longitudinal length and the longitudinal distance is at least 4-1 and up to 4-1, and
the sloped surface of the wedge stop comprises a channel, wherein the width of the channel is within five percent of a width of a rolling surface of the wheel.
